(19) United States
(12) Patent Application Publication
(10) Pub. No.: US 2013/0119630 A1
(43) Pub. Date: May 16, 2013

(54) WHEEL SUSPENSION FOR A MOTOR VEHICLE

(71) Applicant: GM GLOBAL TECHNOLOGY OPERATIONS LLC, Detroit, MI (US)

(72) Inventors: Juergen Hulbert, Eltville (DE); Andreas Stern, Ehlscheid (DE); Gunther Heim, Lampertheim (DE)

(73) Assignee: GM GLOBAL TECHNOLOGY OPERATIONS LLC, Detroit, MI (US)

(21) Appl. No.: 13/672,909

(22) Filed: Nov. 9, 2012

(30) Foreign Application Priority Data
Nov. 11, 2011 (DE) 102011118324.1

(51) Int. Cl. B60G 11/58

(52) U.S. Cl. CPC B60G 11/58
USPC 280/124.162

(57) ABSTRACT

A wheel suspension for a motor vehicle, in particular for an automobile, is provided. The wheel suspension includes a wheel carrier and at least one damper element, which has a first element that can be fastened on the wheel carrier and a second element fastened to a suspension strut dome. The suspension strut dome together with the damper element forms a pre-assembled structural unit.

### CROSS-REFERENCE TO RELATED APPLICATION

This application claims priority to German Patent Application No. 10 2011 118 324.1, filed Nov. 11, 2011, which is incorporated herein by reference in its entirety.

### TECHNICAL FIELD

The present disclosure relates to a wheel suspension for a motor vehicle, in particular for an automobile, comprising a wheel carrier and at least one spring and damper element, which has a first end which can be fastened to the wheel carrier and a second end provided with a support bearing.

### BACKGROUND

Known from the German Unexamined Patent Application 10 2008 010 542 is a vehicle wheel suspension in the form of a suspension strut, with which the bodywork of a motor vehicle is supported on a wheel guiding member. The suspension strut comprises a bearing spring and a damper with a piston rod connected parallel to this, the upper end whereof is fixed with a central nut on a support bearing, the upper section whereof guided out through an opening of a suspension strut dome is ultimately supported on sealing shoulders of the inner side of the suspension strut dome.

Accordingly, it may be desirable to improve the wheel suspension known from the prior art. In addition, other objects, desirable features and characteristics will become apparent from the subsequent summary and detailed description, and the appended claims, taken in conjunction with the accompanying drawings and this background.

### SUMMARY

According to various exemplary embodiments, provided is a wheel suspension for a motor vehicle, in one example, for an automobile, with a wheel carrier and with at least one spring and at least one damper element, which has a first element that can be fastened on the wheel carrier and a second element fastened to a suspension strut dome, where the suspension strut dome together with the damper element forms a pre-assembled structural unit.

The idea of joining together the suspension strut dome with the wheel suspension to form an assembly enables simplified mounting since the assembly is joined together in advance from the wheel suspension and the suspension strut dome and the assembly thus obtained is inserted as a unit into the bodywork of a motor vehicle. By means of a corresponding adaptation of the suspension strut dome with simultaneous adaptation of the damper and spring properties, the assembly can be applied and coordinated in a simple manner to different types of vehicles, in one example, different types of automobiles. In addition, making the support section a component of the wheel suspension assembly opens up the possibility of giving the suspension strut dome different geometrical characteristics and of making it from more diverse materials.

The suspension strut dome is, in one exemplary embodiment, configured as an intrinsically rigid shaped part. Such a suspension strut dome can be inserted in a generally simple manner in a milled-out mounting space of a motor vehicle bodywork, in one example, an automobile bodywork, since no subsequent reinforcing measures are required on the suspension strut dome when installed. In addition, the configuration of the suspension strut dome as a shaped part offers the possibility that this can be inserted at least largely adapted to the contours into the receiving space provided inside the bodywork.

According to another exemplary embodiment of the present disclosure, it is provided that the suspension strut dome is formed as a deep-drawn part made of metal material or as a deep-drawn part comprising a plurality of layers of organic sheet forming a layer structure, whose fiber orientations are adapted to the respective loading profile of the suspension strut dome.

A suspension strut dome configured as a deep-drawn part is generally simple and inexpensive to fabricate. In the event that the deep-drawn part is formed from a plurality of layers of organic sheet joined together to form a layer structure, a noticeable saving in weight can also be achieved.

A suspension strut dome can be manufactured generally simply and in a precisely fitting manner if, according to another exemplary embodiment of the present disclosure, it is provided that the suspension strut dome is configured as a die-cast component, in one example, as an aluminum die-cast component or as a magnesium die-cast component.

According to another exemplary embodiment of the present disclosure, it is provided that the suspension strut dome carries the support bearing at its upper end and at its lower end is fitted with a spring seat generally formed of one material for supporting a support spring, in one example, configured as a helical spring.

In a suspension strut dome having a molded-on spring seat, not only is the number of components to be joined together to form the assembly reduced but at the same time, the tolerance position between the suspension strut dome and the spring seat is also improved. In addition, as a result of the reduction in the components, a simpler component logistics and therefore simplified supply of components to the preassembly workplace is achieved.

According to another exemplary embodiment of the present disclosure, it is provided that the suspension strut dome has two fastening planes arranged at a distance above one another.

In another exemplary embodiment, the lower-lying fastening plane can carry the spring seat to support the support spring.

As a result of the selected type of fastening, the separate structural unit can be integrated by means of the suspension strut dome in a generally positionally stable and stress-optimized manner in the bodywork of a motor vehicle, in one example, an automobile.

In one example, the lower-lying fastening plane is formed by a radial flange-like projection which projects radially with respect to the higher-lying fastening plane.

As a result of this type of fastening, the separate assembly can be connected generally simply and reliably to a longitudinal member of the motor vehicle bodywork, in one example, the automobile bodywork, by means of the suspension strut dome. Due to the lower-lying fastening plane projecting in a flange-like manner, the fastening points on the lower-lying fastening plane are accessible generally easily and therefore in a time-saving manner in series manufacture.

According to another exemplary embodiment of the present disclosure, it is provided that the two fastening planes are arranged circumferentially on the suspension strut dome.

By this means different fastening points for the fastening of the suspension strut dome in a bodywork of a motor vehicle, in one example, of an automobile, can be provided in a generally simple manner.

According to another exemplary embodiment of the present disclosure, it is provided that a motor vehicle, in one example, an automobile is fitted with a wheel suspension as described above.

According to another exemplary embodiment of the present disclosure, it is provided that the motor vehicle has a rear substructure with lateral longitudinal members, which are fitted with a receptacle in which the suspension strut dome of the wheel suspension can be inserted.

By providing a receptacle adapted to the support section, in one example, to the suspension strut dome, the support section, which can be configured as a suspension strut dome or as a damper strut dome, can be inserted in a substantially time-saving and positionally accurate manner in the bodywork of a motor vehicle, in one example, an automobile. If the support section configured as a damper strut dome or as a suspension strut dome is inserted into a receptacle of a longitudinal member and fastened there, a generally flexurally rigid and supporting-rigid connection is made between the support section and therefore between the separate assembly and the bodywork of the motor vehicle, in one example, the automobile.

A generally long-term stable and permanently stressable connection between the structural unit and the bodywork of a motor vehicle, in one example an automobile, is made if according to another exemplary embodiment of the present disclosure, it is provided that the lateral longitudinal members have at least one vertical web at the upper and lower end thereof, respectively one horizontal upper and lower carrying flange is provided, on which the fastening planes of the suspension strut dome rest. As a result of the fastening planes of the suspension strut dome resting on the carrying flanges, the suspension strut dome and therefore the pre-assembled assembly is at the same time integrated positively into the motor vehicle bodywork.

In one example, the higher-lying plane is sealed with respect to the upper carrying flange.

It is thereby ensured in a simple manner that in one example, the interface between the bodywork on the one hand and the pre-assembled assembly on the other hand leading into the motor vehicle interior or into the interior of an automobile is protected from ingress of spray water.

The suspension strut dome and therefore the pre-assembled assembly can be inserted in a substantially simple, time-saving, and positionally accurate manner into the receptacle of the longitudinal frame if according to another exemplary embodiment of the present disclosure, it is provided that the upper carrying flange has at least one guide sleeve on which a guide section of the suspension strut dome mounted in front of the upper fastening plane rests.

In one example, the longitudinal member is configured as a hollow profile, for example, as a hollow profile fitted with a rectangular cross-section, which is composed of two L-shaped individual profiles.

A person skilled in the art can gather other characteristics and advantages of the disclosure from the following description of exemplary embodiments that refers to the attached drawings, wherein the described exemplary embodiments should not be interpreted in a restrictive sense.

### BRIEF DESCRIPTION OF THE DRAWINGS

The various embodiments will hereinafter be described in conjunction with the following drawing figures, wherein like numerals denote like elements, and wherein:

FIG. 1 shows in a simplified schematic view a section of a lateral longitudinal member of a rear automobile substructure with a structural unit according to the present disclosure inserted therein, in sectional view from the side.

### DETAILED DESCRIPTION

The following detailed description is merely exemplary in nature and is not intended to limit the present disclosure or the application and uses of the present disclosure. Furthermore, there is no intention to be bound by any theory presented in the preceding background or the following detailed description.

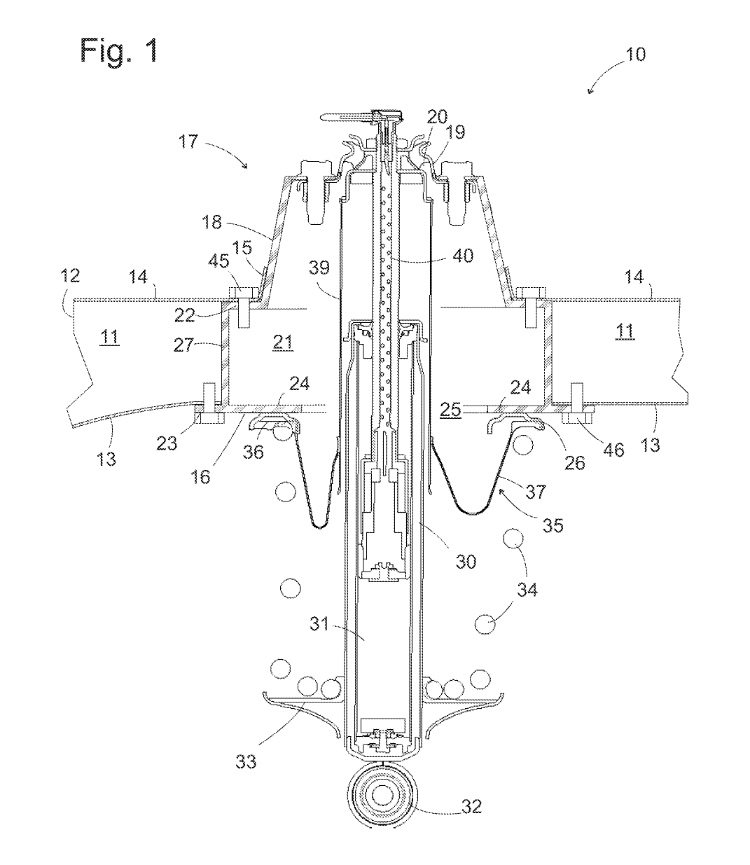

FIG. 1 shows a rear substructure 10 shown in sectional view, which pertains to an automobile not explained in more detail, which rear substructure has two side longitudinal members 11 of which only one longitudinal member 11 is shown in the present example. The longitudinal members 11 are configured in the present example as hollow profiles having a rectangular cross-section and have two vertical supporting webs 12 running at a distance from one another on both sides of the plane of intersection of the FIGURE, of which one is shown. The two supporting webs 12 are connected at their lower edge by a lower horizontally running carrying flange 13 and at their upper edge by a horizontally arranged upper carrying flange 14. Of the two carrying flanges 13 and 14, at least the upper carrying flange 14 is provided with a guide sleeve, which in the present case is bent out from the plane of the horizontal carrying flange 14 and is conically tapered to its free end facing away from the lower carrying flange 13.

Respectively one receptacle 16 is cut free in the two longitudinal members 11, into which the support section configured in the present example as a suspension strut dome 17 is inserted.

In the present example, the suspension strut dome 17 is formed as a hollow profile made of die-cast magnesium and has an upper section 18, which is designed to be conical in the present example, fitting to the guide sleeve 15 which receives said section, an annular fastening flange 19 having a through opening 20 being attached to the tip thereof In the exemplary embodiment shown here the fastening flange 19 is fastened by screws to the suspension strut dome 17, but a one-piece formation with the suspension strut dome 17 is also possible.

The upper section 18 is connected in one piece to a fastening section 21 at its end opposite the front side. The fastening section 21 has a first horizontal fastening plane 22, which is arranged substantially circumferentially on the suspension strut dome 17 similar to an annular flange, and directly adjoins the upper section 18. At a distance below the first fastening plane 22 and connected to this by means of a tubular wall section 27 is a second fastening plane 23, which is formed by a radially, circumferentially arranged flange-like projection, which projects radially with respect to the higher-lying first fastening plane 22, so that a step-like cross-section of the fastening section 21 is obtained between the first fastening plane 22 and the second fastening plane 23.

In the opposite direction to the second fastening plane 23 extending radially outwards from the lower end of the wall section 27, a support flange 24 extends radially into the interior of the suspension strut dome 17. The support flange 24 has a central through opening 25. On its underside facing away from the interior of the hollow-profile like suspension strut dome 17, the support flange 24 is equipped with a spring seat 26, which is arranged in the edge zone of the through opening 25 and is open toward the bottom. Unlike the diagram in the FIGURE, the spring seat can be formed in one piece with the support flange 24, in one example, simply as a groove extending on the underside of the support flange 24 around the through opening 25. A suspension strut projects through the through opening 25, which in a manner known per se comprises a shock absorber 30 and a support spring 34 extending around the shock absorber 30 in a helical line shape. The shock absorber 30 comprises a damper cylinder 31, having a bearing eye 32 fixed at its lower end, with which the shock absorber 30 is fastened to a wheel carrier not shown. At a distance above the bearing eye 32, a spring seat 33 open toward the suspension strut dome 17 is held on the jacket side of the damper cylinder 31, on which the lower end of the support spring 34 is supported, the upper end thereof being held and supported by the spring seat 26.

A bearing flange 36 pertaining to a membrane 35 shaped similarly to a hat and made of an elastic material is provided as an intermediate layer between the upper end of the support spring 34 and the spring seat 26. A membrane wall 37 is formed in one piece on the bearing flange 36, the inner edge thereof abutting in a sealing manner against a protective tube 39 which is movable in a telescopic manner over the damper cylinder 31. The protective tube 39 surrounds a section of a damper piston rod 40 emerging from the damper cylinder 31, the upper end whereof is held on the fastening flange 19 by means of an elastomer bearing received in the through opening 20.

The shock absorber 30 and the suspension strut dome 17 form a pre-assembled assembly, which during assembly of the motor vehicle according to the present disclosure, is inserted from below into the receptacle 16 of the longitudinal member 11 and fixed there. The insertion process is assisted by the guide sleeve 15, which slides along the upper section 18 of the suspension strut dome 17 during insertion into the receptacle 16 and then guides the suspension strut dome 17. In the positionally correct end position of the suspension strut dome 17, its first fastening plane 22 is fastened to the upper carrying flange 14, e.g. by screws 45, possibly assisted by adhesive bonding. Likewise, the second lower-lying fastening plane 24 is screwed to the lower carrying flange 13, where unlike the screws 45, screws 46 of the lower fastening plane 24 are inserted from below.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the present disclosure in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the present disclosure as set forth in the appended claims and their legal equivalents.

What is claimed is:

1. Wheel suspension for a motor vehicle, comprising:
a wheel carrier;
at least one spring; and
a damper element that has a first element that is fastenable on the wheel carrier and a second element fastened to a suspension strut dome,
wherein the suspension strut dome together with the damper element forms a pre-assembled structural unit.

2. The wheel suspension according to claim 1, wherein the suspension strut dome is configured as an intrinsically rigid shaped part.

3. The wheel suspension according to claim 1, wherein the suspension strut dome is formed as a deep-drawn part made of metal material.

4. The wheel suspension according to claim 1, wherein the suspension strut dome is formed as a deep-drawn part further comprising a plurality of layers of organic sheet forming a layer structure, whose fiber orientations are adapted to the respective loading profile of the suspension strut dome.

5. The wheel suspension according to claim 1, wherein the suspension strut dome is a die-cast component.

6. The wheel suspension according to claim 1, wherein the suspension strut dome is an aluminum die-cast component or a magnesium die-cast component.

7. The wheel suspension according to claim 1, wherein the suspension strut dome carries a support bearing at its upper end and at its lower end is fitted with a spring seat formed of one material, for supporting a support spring.

8. The wheel suspension according to claim 7, wherein the suspension strut dome has two fastening planes arranged at a distance above one another.

9. The wheel suspension according to claim 8, wherein a lower-lying fastening plane is formed by a radial flange-like projection which projects radially with respect to a higher-lying fastening plane.

10. The wheel suspension according to claim 8, wherein the two fastening planes are arranged circumferentially on the suspension strut dome.

11. The wheel suspension according to claim 8, wherein the lower-lying fastening plane carries the spring seat for supporting the support spring.

12. A motor vehicle, comprising:
a wheel suspension including:
a wheel carrier;
a suspension strut dome having two fastening planes arranged at a distance above one another;
at least one spring; and
a damper element that has a first element that is fastenable on the wheel carrier and a second element fastened to the suspension strut dome,
wherein the suspension strut dome together with the damper element forms a pre-assembled structural unit.

13. The motor vehicle according to claim 12, further comprising a rear substructure with side longitudinal members, which are fitted with a receptacle in which the suspension strut dome of the wheel suspension can be inserted.

14. The motor vehicle according to claim 13, wherein the lateral longitudinal members have at least one vertical web at the upper and lower end thereof so that respectively one upper and lower carrying flange is provided, on which the fastening planes of the suspension strut dome rest.

15. The motor vehicle according to claim 14, wherein the higher-lying plane is sealed with respect to the upper carrying flange.

16. The motor vehicle according to claim 15, wherein the upper carrying flange has at least one guide sleeve on which a guide section of the suspension strut dome mounted in front of the upper fastening plane rests.

17. The motor vehicle according to claim 14, wherein the longitudinal members are configured as hollow profiles fitted with a rectangular cross-section, which are composed of two L-shaped individual profiles.
